(19) United States
(12) Patent Application Publication
(10) Pub. No.: US 2025/0062084 A1
(43) Pub. Date: Feb. 20, 2025

(54) ELECTRIC SADDLE RIDING VEHICLE

(71) Applicant: Honda Motor Co., Ltd., Tokyo (JP)

(72) Inventors: Derek Hilfer, Columbus, OH (US); John B. Jones, Whitmire, SC (US); Michael V. Peterson, Marysville, OH (US); Benjamin Moninger, Marysville, OH (US)

(21) Appl. No.: 18/449,530

(22) Filed: Aug. 14, 2023

(51) Int. Cl. H01H 13/14; B62J 43/16; B62J 45/00; B62K 11/04; B62M 7/06; H01H 13/20

(52) U.S. Cl. CPC H01H 13/14; B62J 43/16; B62J 45/00; B62K 11/04; B62M 7/06; H01H 13/20; B62K 11/14; B62K 2204/00

(57) ABSTRACT

A key switch assembly for a saddle riding vehicle includes a cover structure adapted to cover a portion of a frame arranged between a handlebar and a seat in a lengthwise direction of the vehicle. A cap structure is removably engaged to the cover structure and includes a first structure disposed inside a cavity of the cover structure and defines an opening, and a second structure extending vertically from the first structure and adapted to be removably coupled to the frame. The second structure is adapted to be arranged underneath the cover structure. A key switch is coupled to the first structure and extends through the opening. The key switch is configured to electrically connect and disconnect the at least one electrical storage unit to the at least one traction motor.

### BACKGROUND

The disclosed subject matter relates generally to vehicles. More particularly, the disclosed subject matter relates to an electric saddle riding vehicle.

Conventionally, key switches (operating on 12 volts) on internal-combustion vehicles are installed on handlebars. Electric vehicles require a high voltage, for example, greater than 60 volts, to run through the key switch to enable a starting of the vehicle. Accordingly, the high voltage electric wires, associated with the key switch that is disposed on the handlebars, are exposed to the user and prone to oscillation during handlebar sweeping, which leads to abrasion of electrical wires, which is undesirable.

### SUMMARY

In accordance with one embodiment of the present disclosure, a key switch assembly for a saddle riding vehicle is disclosed. The saddle riding vehicle has a handlebar, a seat, at least one electrical energy storage unit and at least one traction motor to provide motive power to the saddle riding vehicle. The key switch assembly includes a cover structure adapted to cover a portion of the frame arranged between the handlebar and the seat in a lengthwise direction of the vehicle and defines a central cavity. The key switch assembly further includes a cap structure removably engaged to the cover structure and includes a first structure disposed inside the cavity and defines an opening, and a second structure extending vertically from the first structure and adapted to be removably coupled to the frame. The second structure is adapted to be arranged underneath the cover structure. Moreover, the key switch assembly includes a key switch coupled to the first structure and extending through the opening. The key switch is configured to electrically connect and disconnect the at least one electrical energy storage unit to the at least one traction motor.

In accordance with another embodiment of the present disclosure, a saddle riding vehicle is disclosed. The saddle riding vehicle includes a frame having at least one side tube extending in a lengthwise direction, a handlebar rotatably coupled to the frame and configured to facilitate a steering of the saddle riding vehicle, and a seat mounted on the frame to facilitate a seating of a rider. The saddle riding vehicle also includes at least one electrical energy storage unit, and at least one traction motor operatively coupled to a rear wheel of the saddle riding vehicle and configured to rotate the rear wheel. The saddle riding vehicle further includes a cover structure covering a portion of the at least one side tube extending between the handlebar and the seat in the lengthwise direction of the vehicle. The cover structure defines a central cavity. Moreover, the saddle riding vehicle includes a cap structure removably engaged to the cover structure and including a first structure disposed inside the cavity and defines an opening, and a second structure extending vertically from the first structure and removably coupled to the frame. The second structure is arranged underneath the cover structure. Furthermore, the saddle riding vehicle includes a key switch coupled to the first structure and extending through the opening. The key switch is configured to electrically connect and disconnect the at least one electrical energy storage unit to the at least one traction motor.

In accordance with yet a further embodiment of the present disclosure, a saddle riding vehicle is disclosed. The saddle riding vehicle includes a frame having at least one side tube extending in a lengthwise direction and a bracket structure extending vertically from the at least one side tube. The saddle riding vehicle further includes a handlebar rotatably coupled to the frame and configured to facilitate a steering of the saddle riding vehicle, and a seat mounted on the frame to facilitate a seating of a rider. Furthermore, the saddle riding vehicle includes at least one electrical energy storage unit, and at least traction motor operatively coupled to a rear wheel of the saddle riding vehicle and configured to rotate the rear wheel. Moreover, the saddle riding vehicle includes a cover structure covering a portion of the at least one side tube extending between the handlebar and the seat in the lengthwise direction of the vehicle. The cover structure defines a central cavity, and the bracket structure is arranged underneath the cover structure. The saddle riding vehicle also includes a cap structure removably engaged to the cover structure and including a disc structure disposed inside the cavity and defining an opening, and a leg structure extending vertically from the disc structure and removably coupled to the bracket structure. The leg structure is arranged underneath the cover structure. Further, the saddle riding vehicle includes a key switch coupled to the disc structure and extending through the opening. The key switch is configured to electrically connect and disconnect the at least one electrical energy storage unit to the at least one traction motor.

### BRIEF DESCRIPTION OF THE DRAWINGS

Certain embodiments of the present disclosure will be better understood from the following description taken in conjunction with the accompanying drawings in which:

FIG. 1 is a side perspective of an electric saddle riding vehicle, in accordance with one embodiment of the present disclosure; and

FIG. 2 is a top perspective view of a front portion of the saddle riding vehicle of FIG. 1 depicting a key switch assembly, in accordance with one embodiment of the present disclosure; and

FIG. 3 is a top perspective view of a front portion of the saddle riding vehicle of FIG. 1 depicting a key switch assembly without a cover structure, in accordance with one embodiment of the present disclosure.

### DETAILED DESCRIPTION OF EXEMPLARY EMBODIMENTS

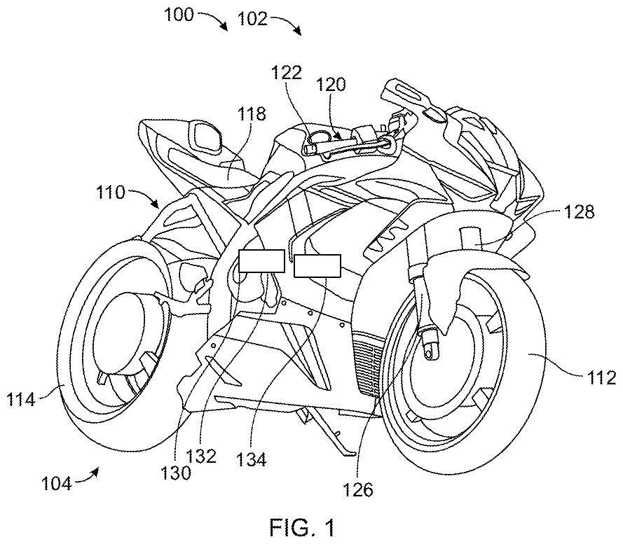

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-3, wherein like numbers indicate the same or corresponding elements throughout the views.

FIG. 1 illustrates a perspective view of a vehicle, indicated generally at 100, in accordance with one embodiment of the present disclosure. As shown, vehicle 100 is an electric saddle riding vehicle 102, for example, a motorcycle 104. Although the saddle riding vehicle 102 is contemplated as the motorcycle 104, it may be envisioned that the saddle riding vehicle 102 may be a scooter, an all-terrain vehicle, or any other similar vehicle known in the art.

As depicted in FIG. 1, the vehicle 100 includes a frame 110, a plurality of wheels, for example, a front wheel 112 and a rear wheel 114, coupled to the frame 110 and adapted to rotate to enable a movement of the vehicle 100 over a path, and a seat 118 supported on the frame 110 to facilitate a seating of at least one person on the vehicle 100. Further, the vehicle 100 includes a handlebar assembly 120 having a handlebar 122, a steering tube 124, and a pair of suspension forks 126, 128 extending downwardly from the steering tube 124 and coupled to the front wheel 112. The steering tube 124 is rotatably coupled to the frame 110 and the handlebar 122 is attached to the steering tube 124 to enable a rotation of the steering tube 124 by a rider to facilitate the steering of the vehicle 100.

Further, the vehicle 100 includes a power source 130, for example, at least one electric traction motor 132, operatively coupled to one of the wheels, for example, the rear wheel 114, to rotate the rear wheel 114 and propel the vehicle 100 in a forward direction. Also, the vehicle 100 may include a transmission (not shown) coupling the power source 130 to the rear wheel 114 to transfer desired torque and speed to the rear wheel 114 from the power source 130. The transmission may be an automatic transmission or a manual transmission. Moreover, the vehicle 104 includes at least one electrical energy storage unit 134, for example, at least one battery 136, to provide electrical power to the at least one electric traction motor 132. Although the at least one electrical energy storage unit 134 is contemplated as a battery, it may be envisioned that the at least one electrical energy storage unit 134 may include one or more of ultracapacitor, supercapacitor, inductors, or a combination thereof. Also, the electrical energy storage unit 134 may be a rechargeable unit configured to be recharged by using a suitable external power source.

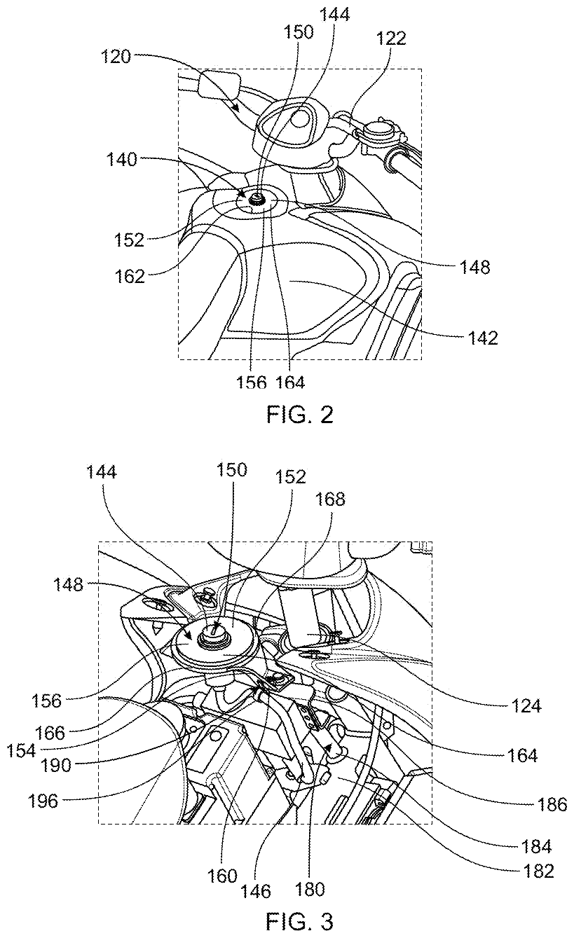

Further, referring to FIGS. 2 and 3, the vehicle 104 includes a key switch assembly 140 having a cover structure 142, a key switch 144, at least one electric cable 146, and a cap structure 148. The cover structure 142 is arranged between the handlebar 122 and the seat 118 in a lengthwise direction, is and adapted to cover, from above, a portion of the frame 110 and components of the vehicle 100 that are disposed between the handlebar 122 and the seat 118. It may be appreciated that the location of the cover structure 142 corresponds to a fuel tank for a conventional engine powered motorcycle.

The key switch 144 or starter switch 144 is configured to electrically connect and disconnect the electrical energy storage unit 134 with the at least one electric traction motor 132 and other electrical components, and is adapted to be displaced between an ON position (i.e., first position) and OFF position (i.e., second position). In the ON position, the at electric current from the electrical energy storage unit 134 flows to the at least one electric traction motor 132 and other electrical devices of the motorcycle 104, while in the OFF position, the at least one electric traction motor 132 is electrically disconnected from the at least one electrical storage unit 134. Accordingly, to operate/start the vehicle 100, the key switch 144 is moved to the ON position. In some embodiment, the key switch 144 may include a keyhole 150 (best shown in FIG. 3) to receive an authorization key that facilitates a user to move the key switch 144 between the ON position and the OFF position. Further, the electric cable 146 that includes electric wires extends outwardly from a lower portion of the key switch 144 and is configured to facilitate flow of electricity from the at least one electrical energy storage unit 134 to the at least one electric traction motor 132. In some embodiments, the electric cable 146 is connected to a power controller (not shown) that controls the flow of electric current from the electrical storage unit 134 to the traction motor 132. The power controller is configured to electrically connect the electrical storage unit 134 to the traction motor 132 when the key switch 144 is at the ON position, while electrically disconnects the traction motor 132 from the electrical storage unit 134 when the key switch 144 is at the OFF position. It may be appreciated that the electric cable 146 is a high voltage cable.

Further, the key switch 144 is supported by and engaged with the cap structure 148 that facilitates the engagement/coupling of the key switch 144 with the frame 110 and the cover structure 142. As shown, the cap structure 148 includes a first structure 152 adapted to be at least partially visible when the cover structure 142 is attached to the frame 110 and a second structure 154 adapted to be disposed underneath the cover structure 142 and removably engaged with the frame 110. In the illustrated embodiment, the first structure 152 includes a disc structure 156 having a central opening, while the second structure 154 includes a leg structure 160 (shown in FIG. 3) extending downwardly from the disc structure 156. In the illustrated embodiment, as shown in FIG. 3, the leg structure 160 extends downwardly from a location proximate to an outer periphery of the disc structure 156. The leg structure 160 is removably engaged with the frame 110 via a suitable fastener.

Further, in the assembly of the cap structure 148 with the cover structure 142 and the frame 110, the cap structure 148 extends inside a circular cavity 162 of the cover structure 142. To enable engagement and retention of the cap structure 148 with the cover structure 142, the disc structure 156 includes an upper portion 164 (i.e., first portion 164) having a diameter substantially equal to the diameter of the central cavity 162 of the cover structure, and a lower portion 166 (i.e., second portion 166) having a relatively larger diameter, thereby defining a step 168 (shown in FIG. 3) therebetween. Accordingly, in the assembly, the cover structure 142 rests on the step 168 such that the upper portion 164 is arranged inside the central cavity 162, while the lower portion 166 is arranged underneath the cover structure 142. Further, an upper portion of the key switch 144 extends inside the central opening and extends downwardly from the upper portion 164 of the cap structure 148 such that the keyhole 150 of the key switch 144 can be accessed easily.

Further, referring to FIG. 3, to enable an easy coupling of the cap structure 148 (i.e., leg structure 160) with the frame 110, the frame includes a bracket structure 180 attached to one or more side tubes 182 of the frame 110 and extending upwardly towards the cover structure 142 from the side tubes 182. As shown, the side tubes 182 extend rearwardly and obliquely from a head end of the frame 110 to which the steering tube 124 is rotatably connected. As shown, bracket structure 180 is welded to one of the side tubes 182, however, it may be appreciated that the bracket structure 180 may be connected to the one or more side tubes 182 by any suitable method or mechanism known in the art. In the illustrated embodiments, the bracket structure 180 includes at least one leg 184 extending vertically upwardly from at least one side tube 182 and includes a seat 186 to which the leg structure 160 of the cap structure 148 is removably engaged. In some embodiments, the leg structure 160 may include at least one retention structure 190 for holding or retaining the electric cable 146. In the illustrated embodiment, the at least one retention structure 190 includes a groove in which a portion of a clip 196 attached to the electric cable 146 is inserted.

In this manner, the saddle riding vehicle 100 includes the key switch 144 that is located to a stationary part of the vehicle 100 and is secured and covered by the cap structure 148 and the cover structure 142 to protect users from high-voltage wires and connections. Further, the cap structure 148 allows the installation of the key switch 144 early in the assembly process so that the wires and wire connections are accessible. Further, the electric cable 146 and the lower part of the key switch 144 are no longer exposed to the user. Also, as the key switch 144 is mounted to a stationary part, the abrasion of the electric cable 146 and the electrical connections is reduced.

The foregoing description of embodiments and examples has been presented for purposes of illustration and description. It is not intended to be exhaustive or to limit the invention to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the invention is, of course, not limited to the examples or embodiments set forth herein, but can be employed in any number of applications and equivalent devices by those of ordinary skill in the art. Rather it is hereby intended the scope of the invention be defined by the claims appended hereto.

What is claimed is:

1. A key switch assembly for a saddle riding vehicle, the saddle riding vehicle having a handlebar, a seat, at least one electrical energy storage unit and at least one traction motor to provide motive power to the saddle riding vehicle, the key switch assembly comprising:
a cover structure adapted to cover a portion of the frame arranged between the handlebar and the seat in a lengthwise direction of the vehicle and defining a central cavity;
a cap structure removably engaged to the cover structure and including
a first structure disposed inside the central cavity and defining an opening, and
a second structure extending vertically from the first structure and adapted to be removably coupled to the frame, wherein the second structure is adapted to be arranged underneath the cover structure; and
a key switch coupled to the first structure and extending through the opening,
wherein the key switch is configured to electrically connect and disconnect the at least one electrical energy storage unit to the at least one traction motor.

2. The key switch assembly of claim 1, wherein the first structure includes a disc structure and the second structure includes a leg structure extending vertically downwardly of the disc structure.

3. The key switch assembly of claim 2, wherein the disc structure includes a first portion and a second portion having a diameter greater than a diameter of the first portion defining a step therebetween, wherein the cover structure is configured to rest on the step.

4. The key switch assembly of claim 3, wherein the first portion extends inside the central cavity, and the second portion is arranged underneath the cover structure in an assembly of the cap structure with the cover structure.

5. The key switch assembly of claim 1, wherein the key switch includes a keyhole to enable an insertion of a key to move the key switch between a first position and a second position.

6. The key switch assembly of claim 1 further including an electric cable extending downwardly of the key switch and adapted to be arranged underneath the cover structure.

7. The key switch assembly of claim 1, wherein the second structure includes a retention structure configured to couple with an electric cable extending from the key switch and retain the electric cable with the second structure.

8. The key switch assembly of claim 7, wherein the at least one retention structure includes a groove configured to receive a portion of a clip engaged with the electric cable.

9. A saddle riding vehicle, comprising:
a frame having at least one side tube extending in a lengthwise direction;
a handlebar rotatably coupled to the frame and configured to facilitate a steering of the saddle riding vehicle;
a seat mounted on the frame to facilitate a seating of a rider;
at least one electrical energy storage unit;
at least one traction motor operatively coupled to a rear wheel of the saddle riding vehicle and configured to rotate the rear wheel;
a cover structure covering a portion of the at least one side tube extending between the handlebar and the seat in the lengthwise direction of the vehicle and defining a central cavity;
a cap structure removably engaged to the cover structure and including
a first structure disposed inside the central cavity and defines an opening, and
a second structure extending vertically from the first structure and removably coupled to the frame, wherein the second structure is arranged underneath the cover structure; and
a key switch coupled to the first structure and extending through the opening,
wherein the key switch is configured to electrically connect and disconnect the at least one electrical energy storage unit to the at least one traction motor.

10. The saddle riding vehicle of claim 9, wherein the first structure includes a disc structure and the second structure includes a leg structure extending vertically downwardly of the disc structure.

11. The saddle riding vehicle of claim 10, wherein the disc structure includes a first portion and a second portion having a diameter greater than a diameter of the first portion defining a step therebetween, wherein the cover structure rests on the step.

12. The saddle riding vehicle of claim 11, wherein the first portion extends inside the central cavity, and the second portion is arranged underneath the cover structure.

13. The saddle riding vehicle of claim 9, wherein the key switch includes a keyhole to enable an insertion of a key to move the key switch between a first position and a second position.

14. The saddle riding vehicle of claim 9, wherein the frame includes a bracket structure arranged underneath the cover structure and extending vertically upwardly towards the cover structure from the at least one seat tube, wherein the second structure is removably engaged to the bracket structure.

15. The saddle riding vehicle of claim 9, wherein the second structure includes a retention structure configured to couple with an electric cable extending from the key switch and retain the electric cable with the second structure.

16. The saddle riding vehicle of claim 15, wherein the at least one retention structure includes a groove configured to receive a portion of a clip engaged with the electric cable.

17. A saddle riding vehicle, comprising:
a frame having at least one side tube extending in a lengthwise direction and a bracket structure extending vertically from the at least one side tube;
a handlebar rotatably coupled to the frame and configured to facilitate a steering of the saddle riding vehicle;
a seat mounted on the frame to facilitate a seating of a rider;
at least one electrical energy storage unit;
at least traction motor operatively coupled to a rear wheel of the saddle riding vehicle and configured to rotate the rear wheel;
a cover structure covering a portion of the at least one side tube extending between the handlebar and the seat in the lengthwise direction of the vehicle and defining a central cavity, wherein the bracket structure is arranged underneath the cover structure;
a cap structure removably engaged to the cover structure and including
a disc structure disposed inside the central cavity and defining an opening, and
a leg structure extending vertically from the disc structure and removably coupled to the bracket structure, wherein the leg structure is arranged underneath the cover structure; and
a key switch coupled to the disc structure and extending through the opening,
wherein the key switch is configured to electrically connect and disconnect the at least one electrical energy storage unit to the at least one traction motor.

18. The saddle riding vehicle of claim 17, wherein the disc structure includes a first portion and a second portion having a diameter greater than a diameter of the first portion defining a step therebetween, wherein the cover structure rests on the step.

19. The saddle riding vehicle of claim 18, wherein the first portion extends inside the cavity, and the second portion is arranged underneath the cover structure.

20. The saddle riding vehicle of claim 17, wherein the second structure includes a retention structure configured to couple with an electric cable extending from the key switch and retain the electric cable with the second structure.
